(19) United States
(12) Patent Application Publication
(10) Pub. No.: US 2018/0341999 A1
(43) Pub. Date: Nov. 29, 2018

(54) CENTRALIZED SYSTEM FOR MANAGING SUBSCRIPTIONS

(71) Applicant: Facebook, Inc., Menlo Park, CA (US)

(72) Inventors: Asad K. Awan, San Francisco, CA (US); Vinay Ramesh Jain, Sunnyvale, CA (US); Rohan Kuruvilla, San Francisco, CA (US); Jyotika Prasad, Santa Clara, CA (US); Huaipeng Zhang, Sunnyvale, CA (US); Jonathan E. Chen, Atherton, CA (US)

(21) Appl. No.: 15/607,287

(22) Filed: May 26, 2017

(51) Int. Cl. G06Q 30/06

(52) U.S. Cl. CPC G06Q 30/0613; G06Q 30/0637; G06Q 30/0601; G06Q 30/0617

(57) ABSTRACT

An online system acts as a centralized, trusted intermediary in managing subscription products that a user of the online system has subscribed to. For example, a user may subscribe to receive a product from a variety of different third party systems. The user of the online system provides payment information and authorization information to the online system which stores them in association with a user profile belonging to the user of the online system. When a payment is required for a subscription product, the online system retrieves the payment information and verifies that the online system is authorized to provide a payment. Once verified, the online system provides a payment on behalf of the user to the third party system in exchange for provision of the subscription product to the user.

### BACKGROUND

This disclosure generally relates to handling subscriptions, and more specifically to centralizing the process of managing subscriptions by a trusted online system.

Users purchase products from third party systems by providing a payment in exchange for the product. A user can provide a payment by providing some form of payment information or credentials including credit/debit card, bank account, or personal check information to the third party system.

Many third party systems offer subscriptions to products and users receive a subscription to a product by either paying a one-time fee for a period of time or provide payments on a recurring basis (e.g., monthly). For convenience, a user may provide payment credentials when purchasing the subscription for the first time and the third party system can store the payment information for future payments. Third party systems may each employ different security features or levels of security for the payment information they receive from users. The differences in security features or the level of security often leaves users concerned about the safety of their payment information as they provide them to a wide variety of third party systems in exchange for various subscriptions and/or products.

### SUMMARY

An online system acts as a centralized, trusted intermediary for managing payment information of users of the online system for subscription products. In various embodiments, a user of the online system provides payment credentials to a centralized system (e.g., the online system) which then manages the subscriptions from various third party systems to ensure that the various subscription products are provided to the user of the online system while users only need to provide their payment information once to a trusted entity.

A user of the online system provides his/her payment information to the online system and additionally authorizes the online system to use the payment information to provide payments to third party systems and/or specific products of the third party systems. The online system stores the received payment information and authorization information to a user profile that belongs to the user of the online system such that the information can be retrieved at a later point if needed.

When the online system receives a payment request, the online system identifies the appropriate user profile of the online system and retrieves the payment information or credentials and authorization information. The online system undergoes a verification process to ensure that the online system is authorized to make a payment to a designated recipient on behalf of the user, which in many cases may be a third party system that is providing a subscription product. Once the payment information is verified, the online system provides the payment on behalf of the user in exchange for the identified product. In various embodiments, the online system provides a payment on behalf of the user at designated time intervals for the subscription product. As such, the online system verifies the payment credentials for each recurring payment to ensure that the desired subscription product is provided. This ensures that the various third party systems do not need to invest resources towards developing security measures for long-term storage of payment information for subscription products.

### BRIEF DESCRIPTION OF THE DRAWINGS

FIG. 1 illustrates a system environment including an online system for the management of subscriptions by an online system, in accordance with an embodiment.

FIG. 2 illustrates the system architecture of the client device, third party system, and online system included in the system environment, in accordance with an embodiment.

FIG. 3A and FIG. 3B each depict an interaction diagram for the management of subscriptions by a trusted online system, in accordance with two embodiments.

The figures depict various embodiments for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of System Environment

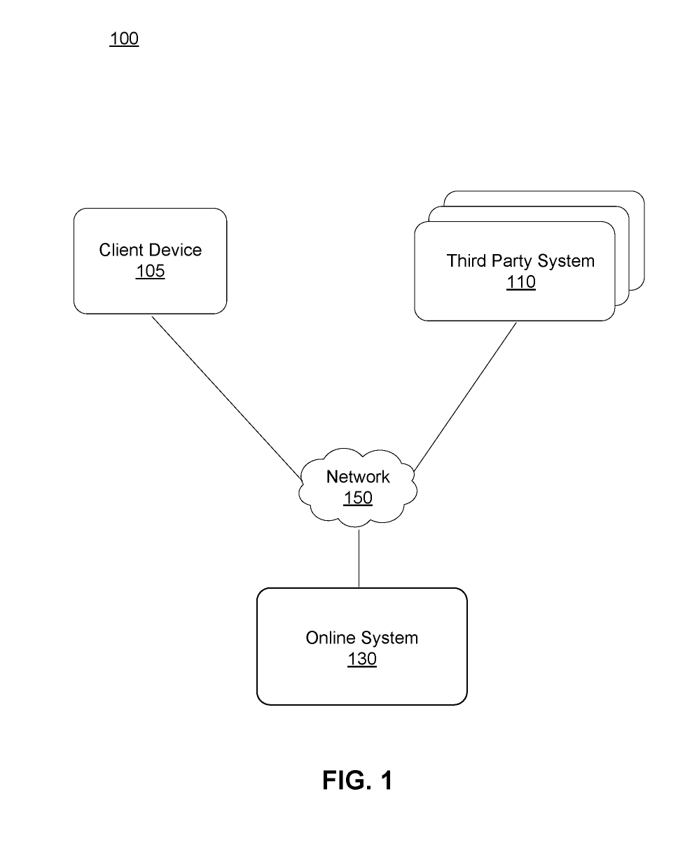

FIG. 1 illustrates a system environment 100 including an online system 130 for managing subscriptions of a third party system 110, in accordance with an embodiment. The system environment 100 includes an online system 130, a client device 105, and one or more third party systems 110, each interconnected through a network 150. In alternative configurations, different and/or additional entities may also be included in the system environment 100.

A client device 105 is accessed by a user to communicate with both the online system 130 and the third party system 110. Examples of client devices 105 include a personal computer (PC), a desktop computer, a laptop computer, a notebook, a tablet PC executing an operating system, for example, a Microsoft Windows-compatible operating system (OS), Apple OS X, and/or a Linux distribution. In another embodiment, the client device 105 can be any device having computer functionality, such as a personal digital assistant (PDA), mobile telephone, smartphone, etc. The client device 105 may execute an application displaying a user interface, for example, an internet browser for allowing the user of the client device 105 to interact with the online system 130 or with the third party system 110.

A user of the client device 105 accesses the online system 130 and provides personal information to the online system 130. For example, the user of the client device 105 can provide login credentials (e.g., an online system user ID, password) to login to the online system 130. Additionally, the user can provide, using the client device 105, payment information or credentials (e.g., bank account information, credit card information, etc.) belonging to the user to the online system 130. In various embodiments, a user also uses the client device 105 to access a third party system 110. For example, the user can purchase and access content, products, or services through a subscription offered by the third party system 110 using the client device 105.

The third party system 110 provides products to its users, such as a user of the client device 105. The term “product” refers to any services, products, and/or content offered by the third party system 110. Examples of products provided by the third party system 110 include music, videos, software, online games, information of different kinds as well as tangible goods, for example, books, equipment, or household items sold online. The third party system 110 offers the products in return for a payment. In various embodiments, the third party system 110 communicates with the online system 130 to receive a payment for one or more products provided to a user of a client device 105.

In various embodiments, the products offered by a third party system are a part of a subscription. The third party system 110 may require a payment at specified intervals of time in exchange for one or more services. For example, the third party system 100 may provide an online game in exchange for a monthly payment (e.g., monthly subscription). Therefore, upon receiving the monthly payment, the third party system 100 provides the client device 105 with access to the online game. If a monthly payment is not received, the third party system 110 terminates access and prevents the client device 105 from further accessing the online game.

The online system 130 acts as a trusted intermediary between the client device 105 and the third party system 110. More specifically, the online system 130 manages the payments on behalf of the user of the client device 105 (e.g., a user of the online system 130) to ensure that the client device 105 can continue to receive one or more products offered by the third party system 110. The user of the client device 105 can access the online system 130 and provide payment credentials. Therefore, when a payment is required for a product of the third party system 110, the online system 130 can provide a payment using the stored payment credentials.

For each user of the online system 130, the online system 130 may store a user profile that includes information associated with the user of the online system 130. Therefore, the payment credentials provided by the user can be stored in an associated user profile. In various embodiments, a user profile includes personal information about the user that was explicitly shared by the user and may also include profile information inferred by the online system 130. In one embodiment, a user profile includes multiple data fields, each describing one or more attributes of the user of the online system 130. Examples of information stored in a user profile include biographic, demographic, and other types of descriptive information, such as work experience, educational history, gender, hobbies or preferences, location and the like. A user profile may also store other information provided by the user, for example, images or videos. In various embodiments, a user profile also includes information associated with the user of the online system 130 that is external to the online system 130. For example, the user profile also includes any user identifiers that the user was previously assigned by a third party system 110 (e.g., a third party user ID) as well as any credentials (e.g., passwords) associated with the user identifiers.

While user profiles stored by the online system 130 are frequently associated with a user of the online system 130, user profiles may also be stored for entities such as the third party system 110. This allows the third party system 110 to establish a presence on the online system 130 for connecting and exchanging content users of the online system 130. While on the online system 130, the third party system 110 may post information about its products on its user profile page that may be available via a subscription.

The online system 130 may maintain a “social graph” to handle the user profiles and information associated with each user profile. A social graph includes nodes that are interconnected by edges. Common examples of nodes include users, non-person entities, content items, groups, events, messages, concepts, and any other things that can be represented by an object or a web page by the online system 130. Therefore, each user profile maintained by the online system 130 may be represented as a node in the social graph. An edge between two nodes in the social graph represents a particular kind of connection between the two nodes, which may result from an action that was performed by one of the nodes on the other node. As an example, a first node may represent a user profile belonging to a first user of the online system 130 and a second node may represent a user profile belonging to a second user of the online system 130. The first user and second user may be connected as “friends” on the online system 130. Therefore, the online system 130 stores an edge between the first and second nodes representing the fact that the two users are connected as “friends.”

The network 150 facilitates communications between the one or more third party systems 110 and the online system 130. The network 150 may be any wired or wireless local area network (LAN) and/or wide area network (WAN), such as an intranet, an extranet, or the Internet. In various embodiments, the network 150 uses standard communication technologies and/or protocols. Examples of technologies used by the network 150 include Ethernet, 802.11, 3G, 4G, 802.16, or any other suitable communication technology. The network 150 may use wireless, wired, or a combination of wireless and wired communication technologies. Examples of protocols used by the network 150 include transmission control protocol/Internet protocol (TCP/IP), hypertext transport protocol (HTTP), simple mail transfer protocol (SMTP), file transfer protocol (TCP), or any other suitable communication protocol.

### Authorization of an Online System

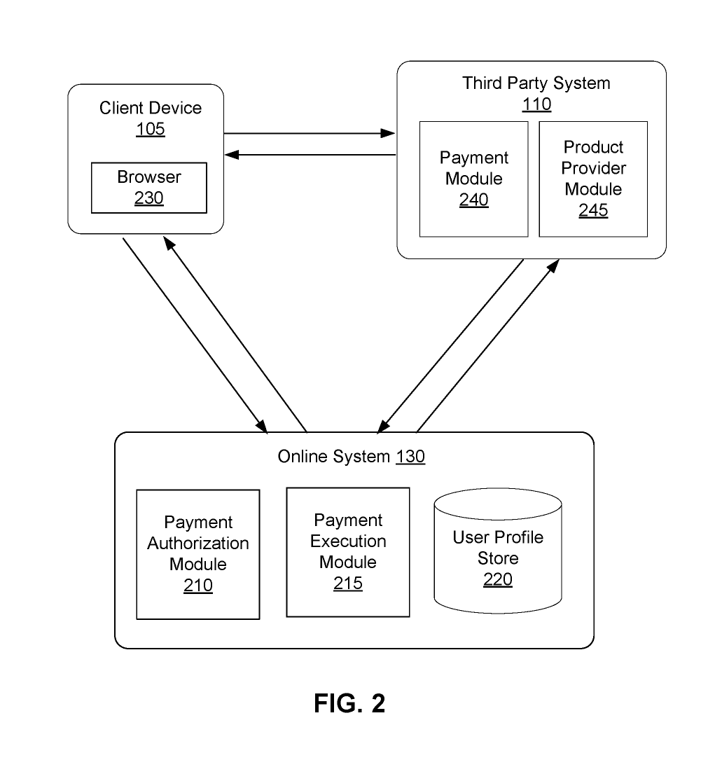

FIG. 2 depicts the system architecture of the client device 105, the third party system 110, and the online system 130 included in the system environment 100, in accordance with an embodiment. The authorization of the online system 130 as a trusted intermediary occurs between the client device 105 and the online system 130. As depicted in FIG. 2, the client device 105 includes a browser 230 for providing payment credentials whereas the online system 130 includes a payment authorization module 210 for authorizing payment credentials.

In various embodiments, a user accesses a browser 230 on the client device 105 to communicate with the online system 130. The user uses the browser 230 to login to the online system 130 and access content on the online system 130. For example, content may be a specific web page configured by the online system 130 to receive payment information through the browser 230 of the client device 105. Therefore, the user can provide payment credentials to the online system 130 using the browser 230 through the specifically configured web page. The payment credentials may include bank account information and/or credit/debit card information associated with the user.

Furthermore, either along with or in addition to the payment credentials, the user can use the browser 230 to provide an authorization that specifies a third party system 110 that the online system 130 is authorized to use the payment credentials for. Alternatively or in addition, the authorization may specify third party systems 110 that the online system 130 must first receive confirmation before using the payment credentials. For example, the authorization may include login credentials (e.g., a third party system user ID and a password associated with the third party system user ID) previously assigned to the user by the third party system 110. In some embodiments, the authorization may include an extra layer of specificity that includes a specification of a particular product of a third party system 110. Therefore, instead of authorizing the payment for any product from a third party system 110 the authorization enables the online system 130 to use the payment credentials to automatically pay for that particular product of the third party system 110.

In various embodiments, the provided authorization also specifies a duration of time that the payment credentials may be used for prior to re-validation. For example, the provided authorization may specify a particular length of time (e.g., 6 months, 1 year) that the payment credentials are to remain valid while stored on the online system 130. As another example, the provided authorization may specify a number of payments (e.g., pay a recurring subscription payment 5 times). Upon passing the specified number of payments, the payment credentials expire and need to be revalidated.

In various embodiments, a user of the client device 105 may include, in the authorization, an identification of other users of the online system 130 that are to be associated with the payment credentials. The online system 130 may set restrictions as to users of the online system 130 that can be associated with the payment credentials. For example, the additional user must be connected to the first user. As another example, the additional user must be connected and related (e.g., father, mother, brother, sister, son, daughter) to the first user. In a scenario, being associated with the payment credentials enables the additional user of the online system 130 to use the payment credentials to pay for purchases and/or subscriptions of their own.

The payment authorization module 210 of the online system is responsible for handling the payment credentials and any additional verification processes that are required prior to making a payment to the third party system 110. The payment authorization module 210 receives the payment credentials and the authorization provided by the user of the client device 105 and verifies the information. As an example, the payment authorization module 210 identifies the user of the online system 130 that provided the payment credentials and verifies that the payment credentials belongs to that user. More specifically, the payment authorization module 210 retrieves information from the user profile of the user of the online system 130 (e.g., retrieved from the user profile store 220) and determines whether the information (e.g., name, address, etc.) matches the provided payment credentials. As another example, the payment authorization module 210 may verify the information through a bank provider associated with the provided payment credentials. The payment authorization module 210 can be configured to be in communication with the bank provider which can verify that the payment credentials are valid and belong to the correct user (e.g., based on the user profile information such as name, address, birth date, etc.).

Once the payment authorization module 210 has conducted the appropriate verification and has successfully verified that the provided payment credentials belong to the user of the online system 130, the payment authorization module 210 stores the payment credentials in a data field corresponding to the user profile of the user of the online system 130. Additionally, the payment authorization module 210 stores the authorization information. For example, the payment authorization module 210 may generate a whitelist of third party systems 110 and/or products of a third party system 110. Thus, future payments that are to be provided to any whitelisted third party system 110 or are to be paid in exchange for a whitelisted product of a third party system 110 can automatically be done so by the online system 130 without further verification. Alternatively, the payment authorization module 210 may generate a blacklist of third party system 110 and/or products of a third party system 110 that the payment credentials are not to be used for. In various embodiments, the authorization information can be stored in conjunction with the payment credentials in a lookup table. In another embodiment, the authorization information is stored with the payment credentials as a key-value pair. Thus, with the payment credentials and authorizations stored in association with a user profile, the online system 130 can serve as a trusted intermediary to provide payments on behalf of the user of the online system 130. At any point, the client device 105 may provide a request to de-authorize the online system 130 as a trusted intermediary, thereby removing the authorization and/or removing the stored payment credentials altogether.

### Managing Subscriptions

Referring again to FIG. 2, the managing of a user's subscription by an online system 130 occurs between the online system 130 and the third party system 110. As depicted in FIG. 2, the online system 130 includes a payment execution module 215 for providing payments to third party systems 110. The third party system 110 includes a payment module 240 for handling all payment related processes.

The payment execution module 215 of the online system 130 executes payments using a user's payment credentials stored in a user profile associated with the user of the online system 130. To do so, the payment execution module 215 receives a payment request to execute a payment, retrieves the appropriate payment credentials based on the payment request, verifies that the online system 130 is authorized to use the payment credentials, and executes the payment.

In various embodiments, the payment execution module 215 receives a payment request that includes identifying information such as a product that would be provided in exchange for a payment (e.g., name of the product, description of the product), the third party system 110 that would be providing the product (e.g., name of the third party system 110), an identifier of a user (e.g., an online system user ID or a third party system user ID) that would be receiving the product. The payment execution module 215 parses out the identifying information and uses them for retrieving and verifying payment credentials.

In various embodiments, the payment execution module 215 uses the information identifying the user of the online system 130 to retrieve the appropriate payment credentials. For example, the identifying information may be a third party system user ID that the user was previously assigned by the third party system 110. As another example, the identifying information is the online system user ID that is assigned to the user of the online system 130. Thus, the payment execution module 215 identifies a user profile from the user profile store 220 that also includes the received third party system user ID and/or is associated with the received online system user ID. In one embodiment, the payment execution module 215 conducts a string comparison to ensure that the third party system user ID and/or the online system user ID received from the request matches the third party system user ID stored in the user profile and/or the online system user ID associated with the user profile. If so, the payment execution module 215 retrieves the payment credentials that are stored in the user profile. If no payment credentials are found in the user profile, the payment execution module 215 can notify the payment authorization module 210 to undertake the authorization process as described earlier.

Upon retrieving the payment credentials, the payment execution module 215 verifies whether the online system 130 is authorized to use the payment credentials to provide a payment for the product that is to be exchanged for the payment. In one embodiment, the payment execution module 215 retrieves the whitelist of third party systems 110 or whitelist of products of a third party system 110. The payment execution module 215 determines whether the information received in the payment request that identifies the third party system 110 (e.g., name of the third party system 110) and/or identifies the product of the third party system 110 (e.g., product name, description of product) can be found on the stored whitelists. If so, then the payment execution module 215 is verified to use the payment credentials to provide a payment for a product of the third party system 110 on behalf of the user of the online system 130.

In various embodiments, the payment execution module 215 may conduct an additional verification step. For example, during the authorization phase, the authorization provided by a client device 105 may have also specified a duration of time or number of payments that the payment credentials may be used for prior before the payment credentials needed to be re-validated. In other words, the payment execution module 215 is authorized to use the payment credentials for the specified duration of time or number of payments. Therefore, the payment execution module 215 may also verify that the duration of time remains valid or that the number of payments has not been exceeded.

If the payment execution module 215 fails to verify the payment credentials, the payment execution module 215 may query the client device 105 to confirm the payment credentials. For example, the payment execution module 215 sends a notification to the client device 105 such as a form that includes the payment credentials (or a portion of the payment credentials such as the last 4 digits of a credit card or bank account) as well as the product of the third party system 110 that is to be provided in exchange for a payment. The form is configured by the payment execution module 215 to enable the user of client device 105 to review the information and provide a confirmation. The payment execution module 215 receives a confirmation from the client device 105 that the payment credentials can be used for providing a payment. In various embodiments, the confirmation may authorize the payment credentials for this single payment. In other embodiments, the confirmation may authorize the payment credentials for a pre-determined period of time or number of payments. Once the payment execution module 215 determines that the payment credentials are authorized, the payment execution module 215 executes and provides the payment to the payment module 240 of the third party system 110 using the authorized payment credentials. In various embodiments, the online system 130 provides the payment credentials to the third party system 110 and the payment module 240 of the third party system 110 can use the payment credentials to receive a payment. In another embodiment, the online system 130 provides a form of currency (e.g., payment tokens) to the third party system 110. The online system 130 and the third party system 110 may have previously agreed to the value of a payment token and as such, the online system 130 can provide the appropriate number of payment tokens as payment to the third party system 110.

The payment module 240 of the third party system 110 handles all payment-related processes for the third party system 110. For example, the payment module 240 sends a request to the payment execution module 215 of the online system 130 for a payment. This request may be triggered by a date of a recurring subscription (e.g., billing date or the subscription). In various embodiments, the request sent by the payment module 240 is an application programming interface (API) or software development kit (SDK) call. The request includes information such as identifying information of the third party system 110, identifying information of the user (e.g., online system user ID, third party system user ID) as well as the product that is to be provided in exchange for the payment.

The payment module 240 receives, in response to the request, a payment from the online system 130 using the payment credentials that the online system 130 was previously authorized to use. Thus, the payment module 240 receives the payment and notifies the product provider module 245 to provide the product.

### Providing a Product

Referring again to FIG. 2, the product provider module 245 of the third party system 110 provides a product or a subscription product to a client device 105. Prior to providing a product, the product provider module 245 checks to see whether payment has been received for the product. If not, the product provider module 245 waits for a notification from the payment module 240 indicating that a payment has been received and subsequently provides the product in response to the received payment. If the payment was previously received, the product provider module 245 provides the desired product.

The product provider module 245 ensures that the product is sent to the desired destination. For example, if the product is a tangible object, the product provider module 245 ensures that the product is shipped, mailed, or readily made available to be obtained by an individual. Alternatively, if the product is an electronic item, the product provider module 245 transmits the product to the client device 105 (or to a previously specified destination).

### Managing Subscriptions by an Online System

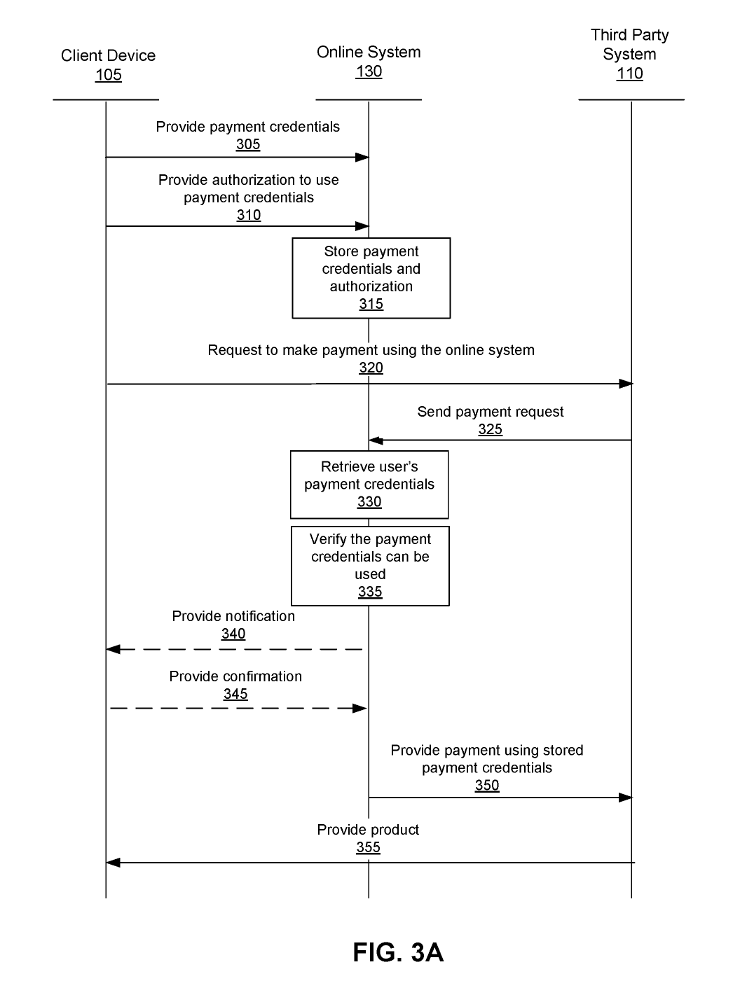

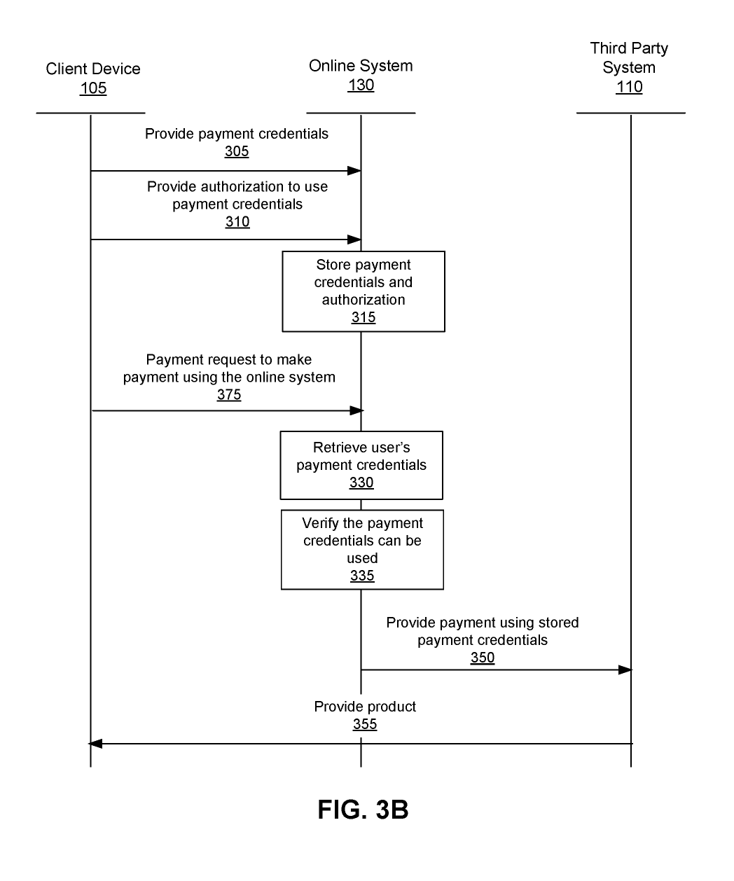

FIG. 3A depicts an interaction diagram for the management of subscriptions by the online system 130, in accordance with an embodiment. In various embodiments, the client device 105 first authorizes the online system 130 as a trusted intermediary. For example, the client device 105 provides 305, to the online system 130, payment credentials belonging to a user of the client device 105 (and a user of the online system 130). Additionally, the client device 105 provides 310 authorization to use the payment credentials to the online system 130. As previously described, the provided authorization can additionally specify third party systems 110 and/or their products that the provided payment credentials can be used for. Therefore, the online system 130 stores 315 the payment credentials as well as the authorization information in a user profile that belongs to the user of the online system 130. Here, the online system 130 may serve as a trusted intermediary on behalf of the user of the online system 130 to provide authorized payments to third party systems 110 that were previously specified in the authorization.

As depicted in FIG. 3A, the client device 105 may request 320 to make a payment using the online system 130. This request is sent to the third party system 110. As an example of this scenario, a browser 230 of the client device 105 is used to browse and purchase products of the third party system 110. The third party system 110 can provide the client device 110 with an option to pay using the online system 130 and therefore, the client device sends a request to do so.

The third party system 110 requests 325 for a payment from the online system 130. The online system 130 retrieves 330 the payment credentials associated with the appropriate user based on identifying information in the received request for a payment. The online system 130 verifies 335 that the online system 130 has been authorized to use the payment credentials for the third party system 110 and/or the product of the third party system 110.

In some embodiments, if the online system 130 determines that use of the payment credentials is unauthorized, the online system 130 may seek authorization from the client device 105. For example, the online system 130 provides 340 a notification to the client device 105 that describes the received payment request. Additionally, the online system 130 can query the client device 105 for authorization to use the stored payment credentials for the third party system 110 and/or the product of the third party system 110. The client device 105 can provide 345 a confirmation to authorize the third party system 110 to use the stored payment credentials. In some embodiments, the confirmation can further specify that the stored payment credentials can be used for only this payment or for some duration of future payments for this third party system 110 and/or product.

Once the online system 130 verifies that the online system 130 is authorized to use the stored payment credentials, the online system 130 provides 350 a payment using the payment credentials to the third party system 110. As such, the third party system 110 can provide 355 the product to the client device 105 and/or to the user of the client device 105

FIG. 3B depicts an interaction diagram for the management of subscriptions by the online system 130, in accordance with a second embodiment. Similar to FIG. 3A, the client device first authorizes the online system 130 as a trusted intermediary through steps 305, 310, and 315. The client device 105 may request to 375 to make a payment using the online system 130. As depicted in FIG. 3B, this request is sent to the online system 130. As an example of this scenario, an online system 130 may present information (e.g., an advertisement) detailing a product of the third party system 110. The user of the client device 105 may choose to provide payment for the product using the online system 130 and as such, the client device 105 provides the request to the online system 130.

Therefore, in the embodiment depicted in FIG. 3B, the online system 130 retrieves 380 and verifies 385 the user's stored payment credentials without receiving a request from the third party system 110 to provide a payment. Upon verification, the online system 130 provides 380 the payment to the third party system 110 using the stored payment credentials. The third party system 110 provides 395 the product to the client device 105 and/or the user of the client device 105.

In various embodiments, the product provided by the third party system 110 is part of a subscription and therefore is provided by the third party system 110 in a recurring fashion. As such, the online system 130 may provide a payment on behalf of the user of the online system 130 using the stored payment credentials each time the product is to be provided. Therefore, the client device 105 (and the corresponding user of the online system 130) need not repeatedly provide payment information for a subscription product. For example, a product may be provided by a third party system 110 to a client device 105 on a repeating pre-determined timed basis (e.g., a monthly magazine subscription or the like). Referring specifically to FIG. 3A, at the end of each pre-determined time period (e.g., end of each month, or end of a billing month), the online system may repeat the steps of receiving 325 a payment request from the third party system 110, retrieving 330 the payment credentials, verifying 335 the payment credentials, and providing 350 the payment using the payment credentials. In this embodiment, the client device 105 (and the corresponding user of the online system 130) need not be involved in managing the recurring subscription and can simply receive 355 the product at each pre-determined time (e.g., monthly).

### General

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving, by an online system, payment information from a user of the online system;
receiving an authorization to use the received payment information, the authorization specifying at least one third party system for the received payment information;
storing the received payment information and received authorization in a user profile associated with the user of the online system;
receiving a payment request for a product associated with a third party system to be provided to the user of the online system;
verifying the stored payment information; and
responsive to the verification, providing a payment using the stored payment information to the third party system.

2. The method of claim 1, wherein verifying the stored payment information comprises:
providing a notification that the payment information are to be used to provide a payment for the product of the third party system; and
receiving a confirmation in response to the provided notification.

3. The method of claim 1, wherein the product is a part of a subscription associated with a repeating pre-determined time period, and wherein verifying the stored payment information is repeatedly conducted at the end of each repeating pre-determined time period.

4. The method of claim 1, wherein the product is a part of a subscription associated with a repeating pre-determined time period, and wherein the online system provides the payment using the stored payment information to the third party system on behalf of the user according to the repeating pre-determined time period of the subscription.

5. The method of claim 1, wherein the at least one third party system received in the authorization is stored by the online system in a whitelist, and wherein verifying the stored payment information comprises matching the third party system associated with the product to a third party system included in the whitelist.

6. The method of claim 1, wherein the authorization further comprises one of a duration of time or a number of payments that the payment information may be used for prior to re-validation.

7. The method of claim 1, wherein the payment request comprises:
at least one of an identification of the third party system or an identification of the product of the third party system; and
an identifier of the user of the online system.

8. The method of claim 7, wherein verifying the stored payment information comprises:
identifying the user profile associated with the user of the online system based on the identifier of the user of the online system included in the received payment request;
receiving the payment information stored in the user profile; and
determining that the stored payment information can be used to provide a payment based on the at least one of the identification of the third party system or the identification of the product of the third party system.

9. The method of claim 1, wherein the payment request is sent by one of a client device associated with the user of the online system or the third party system.

10. The method of claim 1, wherein the authorization further comprises an identification of one or more additional users of the online system to be associated with the payment information.

11. A non-transitory computer-readable medium comprising computer code that, when executed by a processor of a computer, causes the processor to perform the steps comprising:
receiving, by an online system, payment information from a user of the online system;
receiving an authorization to use the received payment information, the authorization specifying at least one third party system that the received payment information can be used for;
storing the received payment information and received authorization in a user profile associated with the user of the online system;
receiving a payment request for a product associated with a third party system to be provided to the user of the online system;
verifying the stored payment information; and
responsive to the verification, providing a payment using the stored payment information to the third party system.

12. The non-transitory computer-readable medium of claim 11, wherein verifying the stored payment information comprises:
providing a notification that the payment information are to be used to provide a payment for the product of the third party system; and
receiving a confirmation in response to the provided notification.

13. The non-transitory computer-readable medium of claim 11, wherein the product is a part of a subscription associated with a repeating pre-determined time period, and wherein verifying the stored payment information is repeatedly conducted at the end of each repeating pre-determined time period.

14. The non-transitory computer-readable medium of claim 11, wherein the product is a part of a subscription associated with a repeating pre-determined time period, and wherein the online system provides the payment using the stored payment information to the third party system on behalf of the user according to the repeating pre-determined time period of the subscription.

15. The non-transitory computer-readable medium of claim 11, wherein the at least one third party system received in the authorization is stored by the online system in a whitelist, and wherein verifying the stored payment information comprises matching the third party system associated with the product to a third party system included in the whitelist.

16. The non-transitory computer-readable medium of claim 11, wherein the authorization further comprises one of a duration of time or a number of payments that the payment information may be used for prior to re-validation.

17. The non-transitory computer-readable medium of claim 11, wherein the payment request comprises:
at least one of an identification of the third party system or an identification of the product of the third party system; and
an identifier of the user of the online system.

18. The non-transitory computer-readable medium of claim 17, wherein verifying the stored payment information comprises:
identifying the user profile associated with the user of the online system based on the identifier of the user of the online system included in the received payment request;
receiving the payment information stored in the user profile; and
determining that the stored payment information can be used to provide a payment based on the at least one of the identification of the third party system or the identification of the product of the third party system.

19. The non-transitory computer-readable medium of claim 11, wherein the payment request is sent by one of a client device associated with the user of the online system or the third party system.

20. The non-transitory computer-readable medium of claim 11, wherein the authorization further comprises an identification of one or more additional users of the online system to be associated with the payment information.
